(19) United States
(12) Patent Application Publication
(10) Pub. No.: US 2021/0067370 A1
(43) Pub. Date: Mar. 4, 2021

(54) VEHICLE CONTROL SYSTEM

(71) Applicant: ADVICS CO., LTD., Kariya-shi, Aichi-ken (JP)

(72) Inventors: Ryosuke ENDO, Nagoya-shi, Aichi-ken (JP); Takayuki YAMAMOTO, Nagakute-shi, Aichi-ken (JP); Tomotaka ASANO, Toyota-shi, Aichi-ken (JP); Tatsushi KOBAYASHI, Kariya-shi, Aichi-ken (JP); Jun NOMURA, Nagoya-shi, Aichi-ken (JP)

(73) Assignee: ADVICS CO., LTD., Kariya-shi, Aichi-ken (JP)

(21) Appl. No.: 16/644,198

(22) PCT Filed: Sep. 28, 2018
(86) PCT No.: PCT/JP2018/036296

§ 371 Date: Mar. 4, 2020

(30) Foreign Application Priority Data
Sep. 29, 2017 (JP) 2017-191501

(51) Int. Cl. H04L 12/40; H04Q 9/02

(52) U.S. Cl. CPC H04L 12/40013; H04L 2012/40273; H04Q 9/02

(57) ABSTRACT

The present invention comprises: a first control device and a second control device that control the operation of a vehicle; a start signal output unit that outputs a start signal to the first control device and the second control device if the vehicle is in a prescribed state; an input detection unit that detects the input of the start signal to the first control device and the second control device in the state in which the start signal has been output to the first control device and the second control device by the start signal output unit; and pause signal output units that output a pause signal to the first control device and the second control device if the state in which the start signal input has been detected by the input detection unit has continued for at least a prescribed amount of time.

### TECHNICAL FIELD

The present invention relates to a vehicle control system that controls an operation of a vehicle.

### BACKGROUND ART

Recently, in order to improve the reliability of an operation of a vehicle, a system is designed with redundancy. For example, when control performed by one control device (for example, an ECU) is performed using two control devices, the redundancy is improved. In the other hand, when more control devices are provided, an increase in electrical power consumption becomes a concern, and thus, it is desirable that the control devices hibernate (enter a sleep state or a power-off state) as much as possible except when necessary. For example, JP-A-2014-227060 discloses a system that efficiently switches a plurality of control devices between a sleep mode and a normal mode.

### CITATION LIST

### Patent Literature

PTL 1: JP-A-2014-227060

### SUMMARY OF INVENTION

### Technical Problem

Here, in the system with the plurality of control devices, in addition to the problem of electrical power consumption, an increase in the size of the system becomes a problem. The invention has been made in light of such circumstances, and an object of the invention is to provide a vehicle control system capable of preventing unnecessary electrical power consumption and preventing an increase in the size of the system.

### Solution to Problem

According to the invention, there is provided a vehicle control system that includes a first control device that controls an operation of a vehicle, a second control device that is provided separately from the first control device to control the operation of the vehicle, and an activate signal output unit that outputs an activate signal to the first control device and the second control device when the vehicle is in a predetermined state, the vehicle control system including an input detection unit that detects an input of the activate signal to the first control device and the second control device in a state where the activate signal output unit outputs the activate signal to the first control device and the second control device; and a hibernate signal output unit that outputs a hibernate signal to the first control device and the second control device when a state where the input of the activate signal is detected by the input detection unit continues for a predetermined period of time or longer.

### Advantageous Effects of Invention

According to the invention, when the input state of the activate signal continues for the predetermined period of time due to abnormality, regardless of the input of the activate signal, it is possible to cause the first control device and the second control device to hibernate. Therefore, it is possible to prevent electrical power consumption in the occurrence of abnormality. Furthermore, in the invention, since it is possible to prevent the electrical power consumption of two control devices not with the input detection units provided in the two control devices but with the input detection unit that is provided in common to the two control devices (namely, with the minimum required configuration), it is possible to prevent an increase in the size of the system.

### BRIEF DESCRIPTION OF DRAWINGS

FIG. 1 is a configuration diagram of a vehicle control system of this embodiment.

FIG. 2 is a time chart illustrating an operation example of this embodiment.

FIG. 3 is a configuration diagram of a vehicle control system of a modification aspect of this embodiment.

FIG. 4 is a configuration diagram of a vehicle control system of a modification aspect of this embodiment.

### DESCRIPTION OF EMBODIMENTS

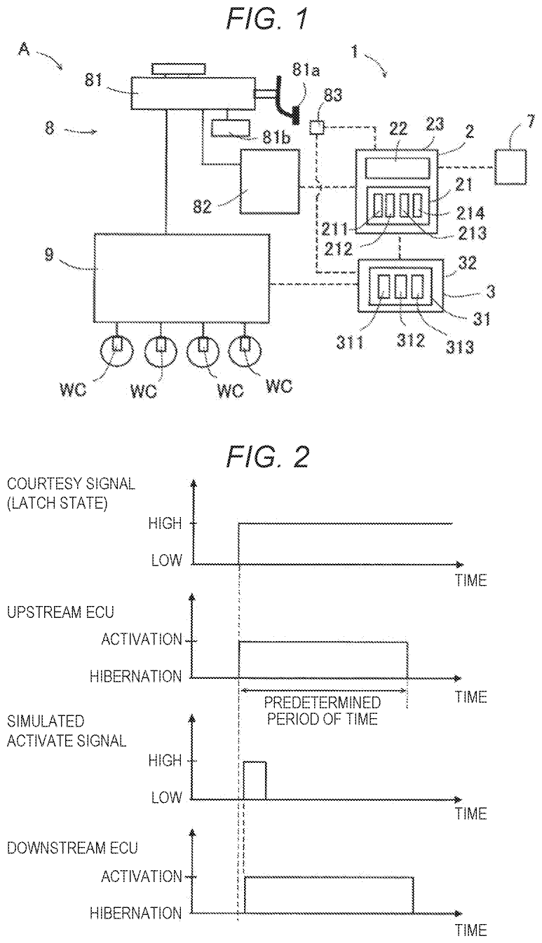

Hereinbelow, an embodiment of the invention will be described with reference to the drawings. Incidentally, each drawing used in the description is a conceptual drawing, and the shape of each part may not necessarily be an exact shape. In this embodiment, as an example, a vehicle control system 1 is applied to a vehicle brake apparatus A. Namely, as illustrated in FIG. 1, the vehicle brake apparatus A includes the vehicle control system 1, an upstream pressurization device 8, a downstream pressurization device 9, and a wheel cylinder WC. Firstly, configurations other than the vehicle control system 1 will be simply described.

The upstream pressurization device 8 is a first device that pressurizes (regulates the pressure) the fluid pressure (hereinafter, referred to as a wheel pressure) of the wheel cylinder WC, and includes a master cylinder 81, a power booster 82, and a stroke sensor 83. The master cylinder 81 is a member that supplies a brake fluid to the wheel cylinder WC via the downstream pressurization device 9 depending on the amount of operation of a brake operation member 81a. A master piston, an elastic member, and the like are disposed and a master chamber is formed, but not illustrated, inside the master cylinder 81. When the master piston moves forward according to the operation of the brake operation member 81a, the fluid pressure (hereinafter, referred to as a master pressure) of the master chamber increases, and the fluid pressure which is supplied downstream increases.

The power booster 82 is a device that applies a driving force to the master piston based on the amount of operation of the brake operation member 81a. The vehicle control system 1 controls the power booster 82 to regulate the driving force of the master piston such that the master pressure reaches a target value. The power booster 82 is, for example, a hydraulic type, and includes an accumulator (high pressure source), a motor, a pump, a pressure regulation device including a pressure boosting valve and a pressure reducing valve which are electromagnetic valves, and a pressure sensor but which are not illustrated. The vehicle control system 1 controls the pressure regulation device to control a servo pressure which is the driving force of the master piston. The stroke sensor 83 is a sensor that detects a stroke which is the amount of operation of the brake operation member 81a. The stroke sensor 83 transmits a detection result to the vehicle control system 1.

The downstream pressurization device 9 is a second device that pressurizes (regulates the pressure) the wheel pressure, and is a so-called actuator. The downstream pressurization device 9 includes a plurality of electromagnetic valves, a motor, a pump, a reservoir, and the like but which are not illustrated. The vehicle control system 1 controls the downstream pressurization device 9 to execute pressurization control, holding control, and pressure reduction control on the wheel cylinder WC. In addition, the vehicle control system 1 controls the downstream pressurization device 9 to be able to execute anti-skid control (ABS control), sideslip prevention control (ESC control), and the like.

The wheel cylinder WC is a device that applies a braking force to a wheel, and is provided in, for example, a caliper or a drum. In addition, the master cylinder 81 is provided with a stroke simulator 81b that generates a reaction force against the brake operation member 81a. In addition, two master chambers are formed, but not illustrated, in the master cylinder 81, and two piping systems (a forward and rearward pipe or a crossover pipe) corresponding thereto are formed in the downstream pressurization device 9.

Here, the vehicle control system 1 of this embodiment will be described. The vehicle control system 1 includes a door switch circuit unit (equivalent to an “activate signal output unit”) 7; an upstream ECU (equivalent to a “first control device”) 2 that controls mainly the upstream pressurization device 8; and a downstream ECU (equivalent to a “second control device”) 3 that controls mainly the downstream pressurization device 9. The upstream ECU 2 and the downstream ECU 3 execute control relating to braking in a coordinated control manner, and are configured to be able to exert a braking force even when one ECU fails.

The door switch circuit unit 7 is a circuit (device) that outputs a courtesy signal (equivalent to an “activate signal”) depending on the opening and closing of a door of a vehicle. When the vehicle is in a predetermined state (here, a door open state), the door switch circuit unit 7 transmits the courtesy signal to a predetermined device (an ECU, an LED lamp, or the like). In other words, the door switch circuit unit 7 transmits the courtesy signal to the predetermined device in conjunction with a predetermined change in vehicle state. The door switch circuit unit 7 is a device that outputs the activate signal to the upstream ECU 2 and the downstream ECU 3 depending on the opening operation of a door provided in the vehicle. The activate signal includes the courtesy signal and a simulated activate signal to be described later. It can be said that when a predetermined vehicle state is detected, the door switch circuit unit 7 outputs the courtesy signal. While the door is open, the door switch circuit unit 7 continues to output the courtesy signal, and when the door is closed, the door switch circuit unit 7 stops outputting the courtesy signal and outputs a reset signal. The door switch circuit unit 7 of this embodiment transmits the courtesy signal as an activate signal to the upstream ECU 2. The door switch circuit unit 7 may be configured to include an ECU.

The upstream ECU 2 is an electronic control unit, and is electrically connected to the downstream ECU 3, the door switch circuit unit 7, and the power booster 82 via communication buses. The upstream ECU 2 and the downstream ECU 3 are connected to each other via a communication bus Z. As configuration elements, the upstream ECU 2 includes a control circuit 21 including a CPU, a memory, and the like, a latch circuit (equivalent to an “input detection unit”) 22, and a case 23 accommodating the control circuit 21 and the latch circuit 22. It can be said that the control circuit 21 is a circuit board aiming to control mainly the upstream pressurization device 8. The functions of the control circuit 21 will be described later.

The latch circuit 22 is a circuit that is common to the upstream ECU 2 and the downstream ECU 3. The latch circuit 22 is a general latch (for example, an SR latch), and when a signal is input to one terminal (for example, a set terminal) (one terminal becomes high), the latch circuit 22 holds an input state (high state) until a signal is input to the other terminal (for example, a reset terminal). The latch circuit 22 is disposed inside the upstream ECU 2, and is electrically connected to the control circuit 21. The latch circuit 22 is a circuit unit (circuit board) that includes, for example, ICs and is separate from the control circuit 21. Therefore, a physical space is required to dispose the latch circuit 22. Since the latch circuit 22 is provided, the case 23 is larger than that when the latch circuit 22 is not provided. Hereinafter, in this embodiment, as an example, a case where the latch circuit 22 is an SR latch will be described.

The latch circuit 22 is electrically connected to the door switch circuit unit 7, and is configured to receive the courtesy signal via the set terminal and the reset signal via the reset terminal from the door switch circuit unit 7. When the courtesy signal is output from the door switch circuit unit 7, “one” is input to the set terminal and the latch circuit 22 enters a set state (can be referred to as the input state or the high state), and when the reset signal is output from the door switch circuit unit 7, “one” is input to the reset terminal and the latch circuit 22 enters a reset state (can be referred to as a non-input state or a low state). Namely, the latch circuit 22 is a circuit that detects the input state and the non-input state (state where the courtesy signal is not input) of the courtesy signal depending on an input of the courtesy signal to the upstream ECU 2. As described above, the latch circuit 22 is a latch circuit that maintains an input state of the activate signal depending on an input of the activate signal (here, the courtesy signal to the upstream ECU 2) to the upstream ECU 2 and the downstream ECU 3. Incidentally, even when “zero” is input to the set terminal of the latch circuit 22 which is in the set state, unless “one” is input to the reset terminal, the latch circuit 22 holds the set state.

Here, the functions of the control circuit 21 will be described. As functional components, the control circuit 21 includes a control unit 211 that controls the upstream pressurization device 8 (power booster 82), an activation processing unit 212, a detection signal output unit 213, and a hibernate signal output unit 214. The activation processing unit 212 monitors the latch circuit 22 to activate the functions of the control unit 211 and the detection signal output unit 213 when the latch circuit 22 is in the set state, namely, when the input state of the courtesy signal is detected by the latch circuit 22. In other words, the activation processing unit 212 activates the entirety (or a part) of the upstream ECU 2 by causing the upstream ECU 2 to execute an activation processing depending on a change in the state of the latch circuit 22.

When the latch circuit 22 is in the set state and the activation processing unit 212 performs the activation processing once, the activation processing unit 212 does not perform the activation processing during operation (during continuous activation) thereafter. Namely, the activation processing unit 212 is set to perform the activation processing only once for one opening and closing operation of the door. As described above, when the state of the latch circuit 22 is changed from the reset state to the set state, the activation processing unit 212 executes the activation processing. When the set state is held or when the state of the latch circuit 22 is changed from the set state to the reset state, the activation processing unit 212 does not execute the activation processing. Only when the upstream ECU 2 is in a hibernate state (a sleep state or a power-off state), the activation processing unit 212 executes the activation processing. Since the activation processing unit 212 can monitor the latch circuit 22 with a small electrical power, even when the upstream ECU 2 hibernates, the activation processing unit 212 can continue to operate.

After the activation processing is completed or while the activation processing is performed, the detection signal output unit 213 outputs a simulated activate signal (equivalent to an “activate signal”) to the downstream ECU 3. In other words, when the latch circuit 22 detects the input state of the courtesy signal, the detection signal output unit 213 outputs the simulated activate signal to the downstream ECU 3.

Here, from the viewpoint of the entirety of the vehicle control system 1, it can be said that the door switch circuit unit 7 outputs an activate signal (simulated activate signal) to the downstream ECU 3 via the upstream ECU 2 depending on an output of an activate signal (courtesy signal) to the upstream ECU 2. Namely, the door switch circuit unit 7 outputs the courtesy signal as an activate signal to the upstream ECU 2, and outputs the simulated activate signal as an activate signal to the downstream ECU 3 via the upstream ECU 2. The door switch circuit unit 7 outputs the activate signal to the upstream ECU 2 and the downstream ECU 3 as a result of outputting the courtesy signal to the upstream ECU 2. It can be said that the door switch circuit unit 7 outputs a signal for activating both ECUs 2 and 3. In this regard, the latch circuit 22 is an input detection unit that detects an input of the activate signal to the upstream ECU 2 and the downstream ECU 3 in a state where the activate signal is output to the upstream ECU 2 and the downstream ECU 3 from the door switch circuit unit 7 (namely, in this embodiment, a state where the courtesy signal is output to the upstream ECU 2). The latch circuit 22 detects an input of the courtesy signal to the upstream ECU 2.

When a state where the input of the courtesy signal is detected by the latch circuit 22 is continuously maintained for a predetermined period of time or longer (when the set state continues for the predetermined period of time or longer), the hibernate signal output unit 214 outputs a hibernate signal to the upstream ECU 2 (each functional component of the upstream ECU 2). The hibernate signal output unit 214 measures the time of continuation of the set state from after activation (or when the state of the latch circuit 22 is changed from the reset state to the set state), and when the set state continues for a predetermined period of time, the hibernate signal output unit 214 outputs the hibernate signal to the control unit 211 and the detection signal output unit 213. It can be said that the hibernate signal is a signal for causing the functions to hibernate (sleep or stop). The hibernate signal output unit 214 outputs the hibernate signal, and the hibernate signal output unit 214 also hibernates. Namely, when the input state continues for the predetermined period of time from activation, regardless of whether or not the courtesy signal is output, the hibernate signal output unit 214 causes the upstream ECU 2 to hibernate. It can be said that the hibernate signal output unit 214 has a timer function, and starts time counting, for example, by triggering the activation of the hibernate signal output unit 214 (or a change of the state of the latch circuit 22 to the set state). Incidentally, for example, when other activate signal (operation signal) which is output when ignition-on, the operation of the brake operation member 81a, or the like is detected is input to the upstream ECU 2, the hibernate signal output unit 214 resets the time measurement, and does not execute an output of the hibernate signal.

The downstream ECU 3 is an electronic control unit, and is electrically connected to the upstream ECU 2 and the downstream pressurization device 9 via communication buses. As configuration elements, the downstream ECU 3 includes a control circuit 31 including a CPU, a memory, and the like, and a case 32 accommodating the control circuit 31. It can be said that the control circuit 31 is a circuit board aiming to control mainly the downstream pressurization device 9. As functional components, the control circuit 31 includes a control unit 311 that controls the downstream pressurization device 9, an activation processing unit 312 that executes an activation processing, and a hibernate signal output unit 313. The activation processing unit 312 is configured to execute the activation processing for the entirety (or a part) of the downstream ECU 3 when the activation processing unit 312 receives the simulated activate signal from the upstream ECU 2.

When the state where the input of the courtesy signal is detected by the latch circuit 22 is continuously maintained for the predetermined period of time or longer (when the set state continues for the predetermined period of time or longer), the hibernate signal output unit 313 outputs a hibernate signal to the downstream ECU 3 (each functional component of the downstream ECU 3). When the set state of the latch circuit 22 continues for a predetermined period of time from the activation of the hibernate signal output unit 313 (or the reception of the simulated activate signal), the hibernate signal output unit 313 outputs the hibernate signal to the control unit 311, and the hibernate signal output unit 313 also hibernates. Similar to the hibernate signal output unit 214 of the upstream ECU 2, when a predetermined condition is satisfied, regardless of whether or not the courtesy signal is output, the hibernate signal output unit 313 causes the downstream ECU 3 to hibernate. In addition, similar to the hibernate signal output unit 214, when the other activate signal (operation signal) is input, the hibernate signal output unit 313 resets the timer and does not execute an output of the hibernate signal. Since the courtesy signal is not directly input to the downstream ECU 3, even when the downstream ECU 3 receives the simulated activate signal to be activated, and then the courtesy signal is continuously output, a determination on the activation or hibernation of the downstream ECU 3 is not affected thereby. As illustrated in FIG. 2, it can be said that the hibernate signal output units 214 and 313 output the hibernate signal to the downstream ECU 3 in conjunction with an output of the hibernate signal to the upstream ECU 2. Incidentally, the predetermined periods of time of the timers in both ECUs 2 and 3 may be set to different values.

Here, in this embodiment, as an example, an operation when a half door state (state where the door is not completely closed) continues will be described. As illustrated in FIG. 2, when the door is open, the courtesy signal is output, and the latch circuit 22 enters the set state. Then, when the half door state continues, the courtesy signal is continuously output, and the latch circuit 22 is held in the set state. The upstream ECU 2 starts the activation processing to be activated depending on a change of the state of the latch circuit 22 to the set state, and starts a measurement of time from activation. The upstream ECU 2 transmits the simulated activate signal to the downstream ECU 3 after activation (there is a slight time lag due to the activation processing). When the downstream ECU 3 receives the simulated activate signal, the downstream ECU 3 starts the activation processing to be activated, and starts a measurement of time from activation. Since the set state continues for a predetermined period of time from activation due to a half door, the upstream ECU 2 and the downstream ECU 3 hibernate after the predetermined period of time. Therefore, even though an irregular state such as the half-door state continues, when there is no input of other operation, both ECUs 2 and 3 hibernate, and the continuous activation of both ECUs 2 and 3 are prevented.

As described above, according to this embodiment, when the input state of the courtesy signal continues for the predetermined period of time due to abnormality such as a half door, regardless of an input of the courtesy signal, it is possible to cause the upstream ECU 2 and the downstream ECU to hibernate. Therefore, it is possible to prevent unnecessary electrical power consumption (in the occurrence of abnormality). Furthermore, in the invention, since it is possible to prevent electrical power consumption in the occurrence of abnormality not with the latch circuits 22 provided in two ECUs 2 and 3 but with only one latch circuit 22 that is provided in common to the two ECUs 2 and 3, it is possible to prevent an increase in the size of the system.

Even when the activation processing unit 212 does not monitor the state of the latch circuit 22 but the reception of the courtesy signal, once the activation processing is performed, the activation processing unit 212 does not perform the activation processing for the time being until the activation processing unit 212 hibernates. However, in this case, when the courtesy signal is continuously received, a command (activate signal) is continuously received, and the upstream ECU 2 cannot hibernate. Namely, the ECU is in the state of continuing to receive a command in the half door state, so that an activation state (operation state) continues. However, according to this embodiment, the upstream ECU 2 is configured to monitor the state of the latch circuit 22 and recognize that a change in the state of the latch circuit 22 from the reset state to the set state is an activate command. Therefore, even when the set state is held for a long period of time due to a half door or the like, the upstream ECU 2 does not receive a command, and can hibernate at a timing that is set in advance. In addition, since the latch circuit 22 holds the set state, it is possible to easily determine whether or not the state continues for the predetermined period of time. In addition, since the latch circuit 22 is disposed in the ECU, it is possible to save a space from the viewpoint of the disposition of wirings and the like.

### Modification Aspects

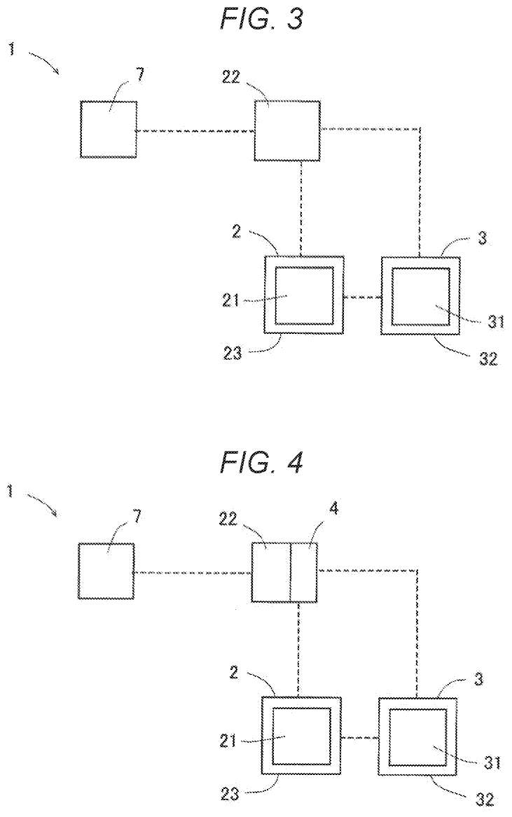

The invention is not limited to the foregoing embodiment. For example, as illustrated in FIG. 3, the latch circuit 22 may be disposed outside the ECUs. In this case, the latch circuit 22 is electrically connected to the door switch circuit unit 7, the upstream ECU 2, and the downstream ECU 3. The latch circuit 22 in the modification aspect also has the function of the detection signal output unit 213, and when the state of the latch circuit 22 is changed from the reset state to the set state, the latch circuit 22 transmits a detection signal to both ECUs 2 and 3. In other words, it can be said that both ECUs 2 and 3 monitor the state (signal state) of the latch circuit 22 that is common thereto.

In addition, as illustrated in FIG. 4, an output circuit unit (equivalent to a “hibernate signal output unit”) 4 which has the functions of the hibernate signal output units 214 and 313 and is common may be connected to the latch circuit 22 in the modification aspect. In this case, when the set state continues for the predetermined period of time from activation, the latch circuit 22 transmits the hibernate signal to both ECUs 2 and 3. Also in the configurations illustrated in FIGS. 3 and 4, similar to the foregoing embodiment, it is possible to prevent unnecessary electrical power consumption with only one latch circuit 22 that is disposed in a plurality of the ECUs 2 and 3, and it is possible to prevent an increase in the size of the system. Since the latch circuit 22 is not provided, the case 23 becomes small. The output circuit unit 4 may be configured to output the detection signal and/or the hibernate signal to both ECUs 2 and 3.

In addition, even though the input state of the courtesy signal turns into the non-input state before the predetermined period of time elapses, when other activation operation (ignition-on or a brake operation) is not performed, the upstream ECU 2 and the downstream ECU 3 may be configured to hibernate after the predetermined period of time from activation. Also in this case, when other operation is not performed and at least the input state continues for the predetermined period of time, the upstream ECU 2 and the downstream ECU 3 are configured to hibernate. In addition, instead of the latch circuit 22, a device which detects the input state and the non-input state of the courtesy signal may be disposed as an input detection unit. In addition, the other activate signal is output, for example, when a brake pedal is depressed or when ignition is on. Namely, other activate signal output unit outputs the activate signal to both ECUs 2 and 3 due to the operation of the brake pedal or ignition-on.

In addition, the hibernate signal output unit 214 may be configured to transmit the hibernate signal not only to the upstream ECU 2 but also to the downstream ECU 3. For example, the hibernate signal output unit 214 may transmit the hibernate signal to the downstream ECU 3 immediately before (or at the same time when) the hibernate signal output unit 214 hibernates. In addition, the vehicle control system 1 may be configured such that the courtesy signal is transmitted to both ECUs 2 and 3. Namely, it can be said that the vehicle control system 1 is configured to be able to output the activate signal to the upstream ECU 2 and the downstream ECU 3. In this configuration, both or one of the ECUs 2 and 3 may be configured to be activated not by a change in the state of the latch circuit 22 but simply by an input of the courtesy signal as a trigger for activation, and to hibernate according to the hibernate signal for hibernation. In addition, the invention can be applied to a plurality of ECUs that control an operation of the vehicle in addition to the plurality of ECUs that controls the braking of the vehicle. Particularly, it is desirable to further improve the reliability of braking control, and the application of the invention enables to secure the redundancy and prevent both electrical power consumption and an increase in the size of the system. The latch circuit 22 may be a known latch other than an SR latch.

In addition, the hibernate signal output unit 214 and the hibernate signal output unit 313 or the output circuit unit 4 may be configured to output the hibernate signal to the upstream ECU 2 and the downstream ECU 3 based on a communication delay in the communication bus Z. In this case, for example, in consideration of the communication delay, the hibernate signal output unit 214 outputs the hibernate signal to the downstream ECU 3 at a point in time ahead of the predetermined period of time before the upstream ECU 2 hibernates. According to such a configuration, it is possible to cause both ECUs 2 and 3 to hibernate at the same timing (substantially the same timing). In addition, in such a configuration, it is possible to omit either one of the hibernate signal output units 214 and 313 in the embodiment illustrated in FIG. 1. Namely, the hibernate signal output unit 214 (or 313) which is common can cause both ECUs 2 and 3 to hibernate. The hibernate signal output unit may be provided in common to the upstream ECU 2 and the downstream ECU 3 or may be provided in each thereof.

1. A vehicle control system that includes a first control device that controls an operation of a vehicle, a second control device that is provided separately from the first control device to control the operation of the vehicle, and an activate signal output unit that outputs an activate signal to the first control device and the second control device when the vehicle is in a predetermined state, the vehicle control system comprising:
an input detection unit that detects an input of the activate signal to the first control device and the second control device in a state where the activate signal output unit outputs the activate signal to the first control device and the second control device; and
a hibernate signal output unit that outputs a hibernate signal to the first control device and the second control device when a state where the input of the activate signal is detected by the input detection unit continues for a predetermined period of time or longer.

2. The vehicle control system according to claim 1,
wherein the first control device and the second control device are connected to each other via a communication bus,
the activate signal output unit outputs the activate signal to the second control device through the communication bus via the first control device depending on the output of the activate signal to the first control device,
the input detection unit detects the input of the activate signal to the first control device, and
the hibernate signal output unit outputs the hibernate signal to the second control device in conjunction with the output of the hibernate signal to the first control device.

3. The vehicle control system according to claim 2,
wherein the hibernate signal output unit outputs the hibernate signal to the first control device and the second control device based on a communication delay in the communication bus.

4. The vehicle control system according to claim 1,
wherein the input detection unit is a latch circuit that maintains an input state of the activate signal depending on the input of the activate signal to the first control device and the second control device, and
the hibernate signal output unit outputs the hibernate signal to the first control device and the second control device when the input state is continuously maintained by the latch circuit for the predetermined period of time or longer.

5. The vehicle control system according to claim 1,
wherein the activate signal output unit outputs the activate signal to the first control device and the second control device depending on an opening operation of a door provided in the vehicle.

6. The vehicle control system according to claim 1,
wherein the input detection unit is a latch circuit that maintains an input state of the activate signal depending on the input of the activate signal to the first control device and the second control device, and
the hibernate signal output unit outputs the hibernate signal to the first control device and the second control device when the input state is continuously maintained by the latch circuit for the predetermined period of time or longer.

7. The vehicle control system according to claim 2,
wherein the input detection unit is a latch circuit that maintains an input state of the activate signal depending on the input of the activate signal to the first control device and the second control device, and
the hibernate signal output unit outputs the hibernate signal to the first control device and the second control device when the input state is continuously maintained by the latch circuit for the predetermined period of time or longer.

8. The vehicle control system according to claim 1,
wherein the activate signal output unit outputs the activate signal to the first control device and the second control device depending on an opening operation of a door provided in the vehicle.

9. The vehicle control system according to claim 2,
wherein the activate signal output unit outputs the activate signal to the first control device and the second control device depending on an opening operation of a door provided in the vehicle.

10. The vehicle control system according to claim 3,
wherein the activate signal output unit outputs the activate signal to the first control device and the second control device depending on an opening operation of a door provided in the vehicle.
